(19) United States
(12) Patent Application Publication
(10) Pub. No.: US 2024/0278482 A1
(43) Pub. Date: Aug. 22, 2024

(54) STRUCTURAL AND VISUAL MODIFICATION OF A POLYMER BY HOT EMBOSSING

(71) Applicant: COATEC PACK EN ABREGE CTP, Perrigny (FR)

(72) Inventor: Mathieu LEYRE, Plaisia (FR)

(21) Appl. No.: 18/570,105

(22) PCT Filed: Jun. 15, 2022
(86) PCT No.: PCT/EP2022/066258

§ 371 Date: Dec. 14, 2023

(30) Foreign Application Priority Data
Jun. 15, 2021 (FR) FR2106298

(51) Int. Cl. B29C 59/00; B29C 59/04; B44C 1/24

(52) U.S. Cl. CPC B29C 59/002; B29C 59/046; B44C 1/24

(57) ABSTRACT

The present invention relates to a hot embossing method that can be used to make a structural and visual modification to a surface polymer. The present invention also relates to the embossing device used to make said structural and visual modification to the surface polymer.

### FIELD OF THE INVENTION

The present invention relates to a hot embossing method that can be used to make a structural and visual modification to a surface polymer. The present invention also relates to the embossing device used to make said structural and visual modification to the surface polymer.

### PRIOR ART

There are many techniques for personalising surfaces for functional and aesthetic purposes. These techniques are currently widely used in the industrial field and are even sometimes employed for personal purposes such as decorative hobbies. Such is the case with silkscreen printing, pad printing, lacquering, varnishing, engraving, vacuum metallisation, or even digital printing. Other techniques specific to metallised surfaces such as dimpling, anodising or the use of chemicals makes local personalisation possible. The same applies for plastic parts the surfaces of which may be modified by graining techniques.

Embossing is a marking technique based on the principle of deforming a material, which makes it possible to create areas in relief on many supports. There are two types of embossing: cold embossing, also known under the name dimpling, and hot embossing. The latter consists in deforming the surface of an object under the action of pressure and of heat, and makes it possible to produce structures in the order of the micrometre to the nanometre. This technique is thus used in many fields such as packaging, electronics or biology. Hot embossing methods are particularly described in US 2006/065136 and EP 1 453 654.

However, the use of these techniques is limited to two-dimensional surfaces, preferably smooth surfaces, or surfaces having small irregularities. Indeed, the presence of irregularities on the surface of the support to be embossed leads to a low, or even poor quality, printing of the pattern. On the other hand, the existing hot embossing methods do not make it possible to create three-dimensional effects or holograms.

Therefore, there is a need to develop a new hot embossing method that makes it possible to personalise surfaces, and that is applicable to any type of support, that is to say to supports having or not surface irregularities, these supports being able to be two- or three-dimensional.

### DISCLOSURE OF THE INVENTION

The present invention relates to a method for hot embossing an object, characterised in that the method comprises a step of hot embossing a surface of the embossable object, with a master plate, said master plate comprising:
a support,
a plate including an embossing pattern, and
a deformable material layer between the support and the plate comprising the embossing pattern,

the step of hot embossing comprising bringing the plate of the master plate into contact with said embossable surface.

Within the scope of the present invention, “deformable material” means any materials having an ability to be deformed under a pressure constant or penetration, such as silicone, foam or any elastomer known by the person skilled in the art. Advantageously, the deformable material layer has a hardness between 50 and 90 Shore A.

Within the scope of the present invention, the plate including the embossing pattern may be a metal sheet.

Within the scope of the present invention “embossable surface” means a surface made of a material the surface of which is modifiable by an embossing method. The object that is embossed may be made, fully or partially, of such a material, or also it may be made of materials the surfaces of which are not embossable in which case it will be applied on the surface of the object, at least on the portion that will be embossed, a polymer layer that will make it possible to hot emboss according to the invention. The present invention also relates to applying a polymer on the surface of the object before the embossing step. In this case, the object is advantageously i) treated with an adhesion primer to promote the adhesion of the polymer to the surface of said object, then ii) a polymer layer is deposited on the adhesion primer.

Additional steps may be included in the embossing method, such as applying a metal or metal oxide layer, and/or applying a protective polymer on at least the embossed surface.

### DESCRIPTION OF THE FIGURES

The features and advantages of the invention will become apparent from the following description of the invention as well as in the examples given by way of non-limiting examples, with reference to the appended figures:

FIG. 1 is a schematic representation of a flat master plate for implementing the method according to the invention

FIG. 2 is a schematic representation of a cylindrical master plate for implementing the method according to the invention.

### DETAILED DESCRIPTION OF THE INVENTION

The object may be a two-dimensional or three-dimensional part, that is to say a part defined by two or three dimensions such as length, width, depth/height. The material constituting the object, and more particularly the surface to be treated may be made of plastic, glass, metal or any other material that can be used for a hot embossing treatment.

The method can be used for various applications, such as applications for structurally and/or functionally personalising an object. This aesthetic and attractive personalisation applies in many fields, such as automotive, household appliances, cosmetics, perfumery or also alcohols for which personalising products and particularly packagings constitutes a commercial advantage.

### Embossable Surface

As described above, embossing is a marking technique based on the principle of deforming a material making it possible to create areas in relief. Therefore, hot embossing consists in deforming the surface of an object under the action of pressure and of heat.

The objects to be embossed therefore have an embossable surface, that is to say compatible with the hot embossing method according to the invention. Thus, the objects, and more particularly the surface of these objects, is made of materials making it possible to implement the hot embossing method. Such materials are known by the person skilled in the art, in particular polymer materials such as polyvinyl chloride (PVC), polycarbonates (PC), polymethyl methacrylate (PMMA), polyesters such as polyethylene terephthalate (PET) or polyterephthalate butylene (PBT), polyamides (PA), or also styrenic polymers, such as acrylonitrile styrene acrylate (ASA) or acrylonitrile butadiene styrene (ABS), etc.

However, when the composition of the surface of the objects does not make it possible to use the hot embossing method directly, a pretreatment step is necessary. The surface of the object to be personalised by hot embossing is thus covered with a polymer layer, said surface consisting of at least one portion of the outer face of the object.

Within the scope of the present invention, “polymer” means polymers that make it possible to perform the hot embossing method. It is understood that the term “polymer” may comprise one or more polymers able to be used in a hot embossing method such as described in the present invention. These polymers are well known by the person skilled in the art who will know how to recognise and select which polymer(s) must be used according to the desired structural modifications.

The outer face of the object to be personalised may be fully or partially covered by the polymer layer. The application of the polymer layer is carried out according to the techniques known by the person skilled in the art. In particular, spray, printing, such as offset printing, photo engraving, silkscreen printing, pad printing, as well as digital printing such as electrography, or ink jet printing deposition methods will be cited.

In a particular embodiment, the step of applying a polymer layer on the surface of the object comprises the substeps of: 1) depositing on the surface of the object a primer promoting the adhesion of the polymer, then 2) depositing the polymer layer on the primer.

The thickness of the polymer layer depends on the material constituting the surface of the object as well as on the structural modifications that are desired during the embossing method. It is understood that the greater the thickness of the polymer layer is, the greater the reliefs formed during the embossing step may be, and vice versa. Thus, the thickness of the polymer layer varies in the order of 1 micrometre to approximately 100 μm, preferably up to 80 μm, more preferably up to 60 μm. Within the scope of the present invention, the polymer layer may have a thickness between 1 and 50 μm.

Advantageously, the method may comprise a step of preparing the surface of the object to be personalised, prior to the step of applying the polymer layer. This preparation step makes it possible to improve the sticking of the polymer layer on the object to be personalised. The preparation step may for example comprise a substep of depositing a primer. In this case, the polymer layer is applied on the primer.

“Primer” means a layer of material making it possible to make the support uniform and/or promote the adhesion of the polymer layer applied subsequently in view of its embossing.

In certain alternative embodiments, the substep of depositing the primer may be preceded by a substep of treating—for example mechanically—the surface of the object intended to receive the primer. This substep of treating the surface is carried out according to the techniques known by the person skilled in the art, such as for example by flame treatment.

Thus, the step of preparing the surface of the object may comprise the substeps of:
treating a surface of the object intended to be personalised, and
depositing a primer on the treated surface to promote the adhesion of the polymer applied subsequently during an application step.

Therefore, the present invention is not limited to the material of the surface of the object to be treated. The object and/or the surface to be embossed may thus be made of plastic, glass, metal or any other material that can be used for a hot embossing treatment with if necessary the prior application of a polymer layer.

### Hot Embossing

The method comprises a hot embossing step corresponding to deforming the embossable surface defined above under the action of pressure and of heat. Such a deformation is performed by using a master plate that will be described in more detail hereinafter.

The master plate is heated and applied on the surface of the object, said surface being covered by the polymer. Under the action of the heat and of the pressure exerted by the master plate, the polymer deforms and acquires the shape defined by a pattern present on the master plate.

The temperature used in the embossing step depends on a plurality of features, and particularly on the glass transition temperature of the surface of the object to be treated, more particularly on the glass transition temperature of the polymer covering the surface of the object to be personalised.

Within the scope of the present invention, the embossing step is carried out at temperatures less than or equal to 300° C. In another embodiment, the embossing step is carried out at a temperature less than or equal to 290° C., or even less than or equal to 280° C. According to the invention, the hot embossing step is carried out at a temperature between 20 and 300° C. In one embodiment, the temperature is greater than or equal to 30° C., greater than or equal to 35° C., greater than or equal to 40° C. In one embodiment, the hot embossing step is carried out at a temperature between 40 and 280° C., preferably between 40 and 270° C., more preferably between 40 and 260° C. Advantageously, the embossing step is carried out at a temperature between 40 and 250° C. According to other embodiments, the embossing step is carried out at temperatures between 40 and 220° C., or even between 50 and 210° C. In other preferred embodiments, the hot embossing is carried out at temperatures between 100 and 120° C., or even between 130 and 150° C. According to another particular embodiment, the hot embossing step is carried out at 60° C., 80° C., 100° C., 110° C. or even 120° C. In another embodiment, the step is carried out at a temperature of 130° C., 140° C., 150° C., 170° C., or even 180° C.

The pressure applied on the surface of the object to be personalised, said surface being covered with a polymer layer, must be sufficient to deform the polymer under the action of heat. According to the invention, the hot embossing step is carried out at a pressure between 2 and 10 bars. In one embodiment, the embossing step is carried out at a pressure greater than or equal to 2 bars. In another embodiment, the pressure is greater than or equal to 3 bars, greater than or equal to 4 bars, greater than or equal to 5 bars, greater than or equal to 6 bars. In another embodiment, the pressure used in the hot embossing step according to the invention is less than or equal to 10 bars. Preferably, the pressure is less than or equal to 9 bars, less than or equal to 8 bars, less than or equal to 7 bars. In another embodiment, the embossing step is performed at a pressure between 2 and 10 bars. Advantageously, bringing the master plate into contact with the surface of the object is carried out at a pressure between 2 and 8 bars, between 3 and 9 bars, between 4 and 7 bars. In one embodiment, the hot embossing step is performed at a pressure of 3 bars, 4 bars, 5 bars, 6 bars, 7 bars, or 8 bars.

In order to have a good quality printing of the pattern on the surface of the object, bringing the master plate into contact on the surface of the object needs to be carried out during a determined period. Thus, within the scope of the invention, the contacting time between the master plate including the pattern to be printed and the surface of the object is carried out during a time in the order of the millisecond to a plurality of seconds. In one embodiment, the contacting time is thus between 0.01 and 5 seconds. In one embodiment, the time is at least 0.001 second. In another embodiment, the contacting time is greater than or equal to 0.005 seconds, greater than or equal to 0.006 seconds, greater than or equal to 0.007 seconds. In another embodiment, the embossing step is carried out in less than 10 seconds, preferably in less than 8 seconds, and preferably in less than 6 seconds. In another embodiment, the embossing step is performed in a time between 0.008 and 6 seconds, preferably between 0.01 and 5 seconds. In a particular embodiment, the embossing step is carried out in 0.01 second, 0.02 seconds, 0.05 seconds, or even 0.08 seconds. In another particular embodiment, the embossing step is carried out in 0.1 second, 0.2 seconds, 0.3 seconds, or 0.5 seconds, or even 0.7 seconds. In another particular embodiment, the embossing step is carried out in 1 second, 2 seconds, 3 seconds, or even 4 seconds.

It is understood that the person skilled in the art will know how to adapt the settings of the pressure, of the temperature, and of the contacting time depending on the nature of the materials used, the patterns to be printed, and the desired embossing quality.

The structural modification of the surface of the object covered by the polymer is carried out under the action of the heat and of a pressure applied by the master plate. The master plate thus makes it possible to reproduce the pattern present on the master plate on the surface of the object.

### Master Plate

In addition to the settings of the hot embossing step, the master plate therefore plays a role in the quality of the embossing. It is thanks to the latter that the heat is transferred on the polymer to be deformed and that the pressure to be applied is performed. Therefore, it must meet the specific pressure and temperature requirements. On the other hand, its design must make it possible to transfer heat and pressure uniformly on the surface of the object.

In order to meet all of these settings, the master plate of the present invention comprises:
a support 1,
a plate 3 including an embossing pattern, and
a deformable material layer 2 between the support 1 and the plate 3.

The master plate may be flat or cylindrical.

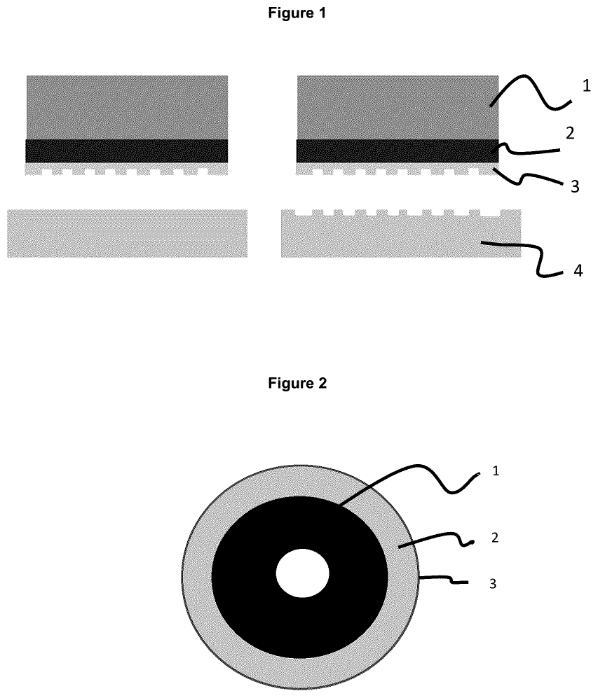

With reference to FIGS. 1 and 2, these three elements are superimposed on one another, the deformable material layer 2 being disposed between the support 1 and the plate 3 according to a “sandwich” type configuration. It will be understood hereinafter that when a layer element A is mentioned as being “on” an element B, it may be directly on the element B, or may be located above the element B and separated from said element B by one or more intermediate elements. It will also be understood that when an element A is mentioned as being “on” an element B, it may cover the entire surface of the element B, or a portion of said element B.

The master plate is mounted on the hot marking head at the support.

With reference to FIG. 1, when the master plate is flat, the support comprises a face outwardly orientated making it possible to connect the master plate to the hot marking head, and a face shared with the deformable material layer.

With reference to FIG. 2, when the master plate is cylindrical, the face of the support that is outwardly orientated is connected to a central axis making it possible to connect the master plate to the hot marking head as well as to rotate the master plate about this axis. The inner face is for its part shared with the deformable material layer.

The support is made of one or more materials, said material(s) having a temperature resistance.

Within the scope of the present invention, the term “temperature resistance” means the absence of alteration in terms of the structural and functional properties of the material when it is subjected to an increase or a reduction of the temperature.

Preferably, the materials used in addition to having a temperature resistance, are also rigid. Thus, “rigid” means the ability of the material to not deform under the action of external mechanical forces. Within the scope of the present invention, the rigid materials are defined by a Young's modulus between 50 GPa and 300 GPa. Within the scope of the present invention, the term materials groups pure metals, such as for example zirconium, aluminium, gold, zinc, silver, palladium, copper, iron, platinum, cobalt, nickel, chromium; alloys the composition of which makes it possible to have a Young's modulus between 50 and 300 GPa, such as steel, bronze, brass; or also glasses and metal carbides such as for example carbon fibres or high-carbon steel.

The support may therefore consist of one or more rigid materials. The person skilled in the art will know how to select the appropriate compounds depending on the use that is to say depending on the features of the method and of the desired result. In a preferred embodiment, the support is made of a pure metal, preferably aluminium. In another embodiment, the support is made of alloy, preferably steel or brass. In one embodiment, the steel is stainless steel. In another embodiment, the support is made of metal carbides. Preferably, the material used for the support is aluminium, stainless steel, brass or steel.

The support has a thickness in the order of a plurality of millimetres. Within the scope of the present invention, the thickness of the support is between 1 and 50 mm, preferably between 1 and 30 mm. In another embodiment, the thickness of the support is greater than or equal to 1 mm, greater than or equal to 1.2 mm, greater than or equal to 1.5 mm, greater than or equal to 1.8 mm. In preferred embodiment, the thickness is greater than or equal to 2 mm. Advantageously, the thickness of the support is less than or equal to 30 mm, less than or equal to 28 mm, less than or equal to 26 mm, or even less than or equal to 22 mm. Advantageously, the support has a thickness less than or equal to 20 mm. In a preferred embodiment, the support of the master plate has a thickness between 2 and 20 mm. In a preferred embodiment, the support has a thickness of 5 mm, 8 mm, 10 mm, 12 mm, 15 mm or also of 18 mm Thus, this support makes it possible to connect the hot marking head and the plate comprising the embossing pattern that will be reproduced on the surface of the object.

The plate is advantageously a metal sheet made of a metal, such as aluminium, nickel, magnesium, copper or lead, or of an alloy such as brass or bronze. In a preferred embodiment, the plate is manufactured from aluminium, nickel, magnesium or brass, or a mixture thereof.

This plate comprises the pattern to be embossed. The latter is performed according to techniques well known by the person skilled in the art. Thus, it may be performed by laser engraving, chemical or mechanical reaction, by electrolysis or electroplating, or also by milling. In a preferred embodiment, the pattern is obtained according to an engraving method or by electroplating.

The person skilled in the art will know how to select the material(s) to be used for the composition of the plate, as well as the most appropriate technique for reproducing the pattern thereon.

The thickness of the plate is between 50 μm and 1 mm. In one embodiment, the thickness is less than or equal to 1 mm, less than or equal to 0.9 mm, less than or equal to 0.8 mm. In another embodiment, the thickness is greater than or equal to 50 μm, greater than or equal to 70 μm, or even greater than or equal to 90 μm. Thus, the plate including the pattern to be embossed has a thickness between 90 μm and 750 μm, preferably between 100 μm and 700 m, more preferably between 100 μm and 600 μm, also more preferably between 100 μm and 500 μm. In one embodiment, the plate has a thickness of 100 μm, 150 μm, 200 μm, 250 μm or also of 300 μm.

Between the support and the plate comprising the pattern to be embossed, is a deformable material layer. This layer particularly makes it possible to uniformly distribute the pressure and attenuate, or even prevent the negative effect of the presence of imperfections on the surface of the object to be embossed on the quality of the embossing.

Within the scope of the present invention, the deformable material layer is characterised by a hardness greater than or equal to 50 Shore A, and less than or equal to 90 Shore A. Thus, in one embodiment, the hardness is between 50 and 90 Shore A, preferably between 60 and 80 Shore A.

The deformable material layer may comprise one or more materials.

Within the scope of the present invention, the deformable material layer is preferably made of silicone, polyurethane or of any other elastomer known by the person skilled in the art.

Examples of elastomers that may be included in the composition of the layer are natural and synthetic rubbers of which rubbers based on butadiene-acrylonitrile copolymers, rubbers based on carboxylated nitrile copolymers, rubbers based on hydrogenated butadiene-acrylonitrile copolymers, rubbers based on polychloroprene, or also ethylene-propylene-diene rubbers.

The deformable material layer may also comprise elastomers based on silicone. “Silicone” means the inorganic compounds formed of a silicon-oxygen chain that may moreover be functionalised. Within the scope of the present invention, the silicones used are preferably in an elastomer type form. Other elastomers also such as fluoroelastomers (fluorocarbon elastomers, perfluoroelastomers) and polyurethanes may be included in the composition of the deformable material layer.

Moreover, the embossing method is carried out at temperatures between 20 and 300° C. Thus, the deformable material layer must have a sufficient resistance to the temperatures that are used in the implementation of the method. Within the scope of the present invention, the deformable material layer has a temperature resistance reaching up to 300° C.

Due to their particular properties, ideal resilience properties, particularly a long-term resilience, a resistance to high temperatures, and hardness properties, silicones and more particularly elastomers based on silicone are excellent compounds for forming such a layer. Thus, in a preferred embodiment, the deformable material layer will comprise at least one compound or elastomer based on silicone. In another embodiment, the deformable material layer is only made of silicone.

As for the thickness of the deformable material layer, this is in the order of a few micrometres to a plurality of millimetres, preferably the thickness of the deformable material layer is between 100 μm and 5 mm. In one embodiment, the thickness of the deformable material layer is greater than or equal to 100 μm, greater than or equal to 200 μm, greater than or equal to 250 m. In another embodiment, the deformable material thickness is less than or equal to 5 mm, less than or equal to 4 mm, less than or equal to 3 mm. The deformable material layer thus comprises a thickness of 300 μm to 3 mm, preferably of 350 μm to 2 mm, more preferably of 400 μm to 2 mm, also more preferably of 500 μm to 2 mm. Advantageously, the deformable material layer has a thickness of 500 μm, 750 μm 1 mm, 1.5 mm, or also of 2 mm.

The master plate, thus made of 3 elements superimposed on one another, is mounted on the hot marking head. It is understood that all of the materials constituting the master plate, that is to say the materials used for manufacturing the support, the deformable material layer and the plate including the pattern to be embossed, are resistant to high temperatures. The person skilled in the art will know how to select the materials appropriate for the composition of said master plate. Within the scope of the present invention, the materials particularly have a resistance to temperatures that may reach up to 300° C., or even 310, or even 320° C., or even 350° C.

### Varnishing

Once the pattern has been reproduced on the surface of the object, additional treatments may be envisaged, particularly in the aim of protecting against external mechanical or physical attacks (scratches, external impacts, chemical attacks).

Within the scope of the present invention, applying a metal or oxide layer, such as aluminium, or also applying a protective polymer such as a varnish may be implemented. These treatments may be performed independently of or to complement one another. Thus, it will be possible to treat the pattern either with a metal or oxide layer, or with a protective polymer. According to another embodiment, it will also be possible to treat the pattern with a metal or oxide layer and a protective polymer. These compounds are applied according to techniques well known by the person skilled in the art, such as for example by evaporation or sputtering.

In addition, applying a metal or oxide layer, or also applying a protective polymer may constitute successive steps without interrupting the industrial flow line, or be performed independently of one another, that is to say with a break of the industrial flow line.

### Other Optional Steps

It is understood that treatments other than those listed in the present invention may be performed. The person skilled in the art will know how to determine which treatments need to be performed on the objects depending on their uses and on the desired technical or aesthetic effects.

The embossing method of the present invention described above can be used to make the structural or functional modification to a polymer present on the surface of the object. This method may be implemented on many supports.

Thanks to the design of the master plate including a deformable material layer, hot embossing may be performed on supports having surface irregularities without thereby affecting the quality of the pattern represented on the surface of the object. In addition, hot embossing may be performed on two-dimensional or three-dimensional parts.

### EXAMPLES

### Example 1: Hot Embossing a PET Injected Cover

Features of the part: PET (polyethylene terephthalate) injected cover, cylindrical and developable part of a diameter of 33 mm and of a height of 42 mm

Features of the master plate: The master plate comprises a support plate made of aluminium of 10 mm of thickness, a silicone layer of hardness of 70 Shores and of 2 mm of thickness, and a brass plate of 300 μm of thickness. The pattern to be embossed has been engraved beforehand on the brass plate by chemical etching.

### Embossing Procedure:

The flat master plate is mounted on the hot marking head, then heated to a temperature in the order of 130-150° C. at its surface.

The part is brought into contact with the surface of the engraved brass plate, itself at the temperature described above, by way of a horizontal movement. This contact, hot and by applying a pressure/penetration defined according to the dimensional features of the part, reproduces the graphics and the text of the master plate over the entire surface of the object, in spite of any dimensional variations related to the injection method.

### Example 2: Hot Embossing a Drawn Glass Vial

Features of the part: Drawn glass vial, cylindrical and developable part of diameter of 9 mm and of height of 40 mm

Features of the master plate: The master plate comprises a support plate made of aluminium of 5 mm of thickness, a silicone layer of hardness 70 Shores and of 2 mm of thickness, and a nickel plate of 100 μm of thickness. The nickel plate is obtained by electroplating and has on its surface a holographic structure (hologram).

### Embossing Procedure:

### 1) Preparing the Surface of the Object

The vial is flame treated, then successively covered by spraying an adhesive primer, as well as a varnish, made of a plurality of polymers the chemical nature of which may be of a plurality of natures, acrylic in particular.

### 2) Hot Embossing

The flat master plate is mounted on a hot marking head, and heated to a temperature in the order of 100-120° C.

The vial is brought into contact with the master plate (in particular with the nickel sheet having the holographic structure), itself heated to the temperature described above, by way of a horizontal movement. This contact, hot and by applying a pressure/penetration defined according to the dimensional features of the part, makes it possible to reproduce the holographic structure on the surface of the polymer deposited by spraying on the glass vial.

### 3) Varnishing

An aluminium layer is subsequently deposited by evaporation to enhance the holographic structure. A protective varnish is finally applied by spraying in order to protect the aluminium layer and provide a colour personalisation.

### Example 3: Hot Embossing a Flat Cover Made of ABS Coated with a Varnish

Features of the part: Flat cover injected with ABS (Acrylonitrile Butadiene Styrene) coated with a varnish that the person skilled in the art will know how to select according to the required technical requirements. Diameter 60 mm, thickness 3 mm.

Features of the master plate: The master plate comprises a support plate made of aluminium of 10 mm of thickness, a silicone layer of hardness of 70 Shores and of 2 mm of thickness, and a brass plate of 300 μm of thickness. The pattern to be embossed has been engraved beforehand on the brass plate by laser.

### Embossing Procedure:

The flat master plate is mounted on the hot marking head, then heated to a temperature in the order of 160-180° C. at its surface.

The flat master plate, at the temperature described above, is brought into contact with the varnish injected flat cover by way of a vertical strike. The contact time, in the order of 1 second, combined with the application of a pressure/penetration defined according to the dimensional features of the part, makes it possible to reproduce the graphics and the text of the master plate over the entire surface of the cover, in spite of any dimensional variations related to the injection method.

What is claimed is:

1. Method for hot embossing an object, wherein the method comprises a step of embossing an embossable surface of the object with a master plate,
said master plate comprising:
a support (1),
a plate (3) including an embossing pattern, and
a deformable material layer (2) between the support and the plate comprising the embossing pattern,
the embossing step comprising bringing the plate of the master plate into contact with said embossable surface.

2. Method according to claim 1, wherein the deformable material layer (2) is made of a material having a hardness between 50 Shore A and 90 Shore A.

3. Method according to claim 1, wherein the deformable material layer (2) is a silicone layer.

4. Method according to claim 1, wherein the method further comprises a step of applying a polymer layer on the surface of the object before the step of hot embossing, said surface consisting of at least one portion of the outer face of the object.

5. Method according to claim 1, wherein the embossing step is performed at a temperature between 40 and 250° C.

6. Method according to claim 1, wherein the embossing step is performed at a pressure between 2 and 10 bars.

7. Method according to claim 1, wherein bringing the plate of the master plate into contact with the embossable surface including the polymer layer is performed during a time of 0.01 second and 5 seconds.

8. Method according to claim 1, wherein the support (1) is made of a material selected from aluminium, stainless steel, brass or steel.

9. Method according to claim 1, wherein the plate (3) including the embossing pattern is a plate made of aluminium, nickel, brass, magnesium.

10. Method according to claim 1, wherein the embossing pattern of plate (3) is obtained by engraving, electroplating, laser, or chemical reaction.

11. Method according to claim 1, wherein the deformable material layer (2) has a thickness between 100 μm and 5 mm.

12. Method according to claim 4, wherein the step of applying a polymer layer on the surface of the object comprises the following substeps of:
depositing, on the surface of the object, a primer promoting the adhesion of the polymer (4), and
depositing the polymer layer (4) on the primer.

13. Method according to claim 1, wherein the method further comprises a step of applying a metal or oxide layer after the embossing step.

14. Method according to claim 1, wherein the method further comprises a step of applying a protective polymer after the embossing step.

15. Method according to claim 14, wherein the protective polymer is a varnish.

16. Method according to claim 1, wherein the deformable material layer (2) has a thickness comprised between 100 μm and 5 mm.

17. Method according to claim 1, wherein the support (1) has a thickness comprises between 1 and 50 mm.

18. Method according to claim 1, wherein the plate has a thickness comprised between 50 μm and 1 mm.
